(19) United States
(12) Patent Application Publication
(10) Pub. No.: US 2017/0297488 A1
(43) Pub. Date: Oct. 19, 2017

(54) SURROUND VIEW CAMERA SYSTEM FOR OBJECT DETECTION AND TRACKING

(71) Applicant: GM Global Technology Operations LLC, Detroit, MI (US)

(72) Inventors: Jinsong Wang, Troy, MI (US); Upali P. Mudalige, Oakland Township, MI (US); Xinhua Xiao, Madison Heights, MI (US); Jie Yin, Rochester, MI (US); Wende Zhang, Troy, MI (US); Guangyu J. Zou, Warren, MI (US)

(21) Appl. No.: 15/487,521

(22) Filed: Apr. 14, 2017

Related U.S. Application Data
(60) Provisional application No. 62/324,602, filed on Apr. 19, 2016.

(51) Int. Cl. B60R 1/00; H04N 7/18; H04N 5/247; G06K 9/00; G01S 19/13; B60R 11/00; B60R 11/04

(52) U.S. Cl. CPC B60R 1/00; H04N 5/247; H04N 7/18; G06K 9/00791; B60R 2300/105; B60R 2011/004; B60R 2300/8066; B60R 11/04; G01S 19/13; B60R 2300/8093

(57) ABSTRACT

A method to equip a vehicle to perform object detection and tracking and a surround view camera system to perform the object detection and tracking involve two or more cameras arranged respectively at two or more locations of the vehicle. The cameras capture images within a field of view of the two or more cameras. A processing system obtains the images from the two or more cameras and performs image processing to detect and track objects in the field of view of the two or more cameras.

### CROSS REFERENCE TO RELATED APPLICATION

This application claims the benefit of priority of U.S. Provisional Application No. 62/324,602 filed Apr. 19, 2016, the disclosure of which is incorporated herein by reference in its entirety.

### INTRODUCTION

The subject disclosure relates to a surround view camera system for object detection and tracking.

Cameras are increasingly used in vehicles (e.g., automobiles, construction equipment, farm equipment, automated manufacturing facilities) for automation and safety systems. Surround-view or rear cameras provide images that facilitate an enhanced view during parking, for example. Forward-looking cameras are used alone or in combination with other sensors (e.g., radar, lidar) to detect and track objects and enable semi-autonomous driving, for example. However, the field of view of the forward-looking camera is insufficient in many scenarios. For example, in a parking lot, in which other vehicles or pedestrians may be approaching from any direction, the forward-looking camera system cannot detect a potential threat of collision. As another example, when an adjacent vehicle changes lanes without allowing sufficient space, that vehicle may not be detected by a forward-looking camera system. Accordingly, it is desirable to provide a surround view camera system for object detection and tracking.

### SUMMARY

In one exemplary embodiment, a surround view camera system in a vehicle includes two or more cameras arranged respectively at two or more locations of the vehicle. The two or more cameras capture images within a field of view of the two or more cameras. The system also includes a processing system to obtain the images from the two or more cameras and perform image processing to detect and track objects in the field of view of the two or more cameras.

In addition to one or more of the features described herein, the processing system performing image processing includes the processing system pre-processing each of the images individually including de-warping each of the images.

In addition to one or more of the features described herein, the processing system being configured to perform image processing includes the processing system being configured to perform visual recognition techniques to detect the objects in each of the images in which the objects appear.

In addition to one or more of the features described herein, the processing system being configured to perform image processing includes the processing system being configured to perform inter-image detection to detect the objects based on overlapping areas in the images obtained by the two or more cameras.

In addition to one or more of the features described herein, the processing system being configured to perform image processing includes the processing system being configured to perform temporal detection on a frame-by-frame basis to track movement of the objects.

In addition to one or more of the features described herein, the processing system is further configured to obtain vehicle dynamics information about the vehicle.

In addition to one or more of the features described herein, the processing system is further configured to obtain information from other sensors of the vehicle, the other sensors including a radar system, a lidar system, or an ultrasonic sensor system.

In addition to one or more of the features described herein, the processing system is further configured to output information about the locations of the objects in the field of view of the two or more cameras in a vehicle coordinate system.

In addition to one or more of the features described herein, the processing system is further configured to present the objects in the field of view of the two or more cameras in a three-dimensional bounding box (BBOX).

In addition to one or more of the features described herein, the processing system is further configured to provide information about the objects in the field of view of the two or more cameras to a controller in the vehicle, the controller being configured to control safety and autonomous systems of the vehicle.

In another exemplary embodiment, a method of equipping a vehicle to perform object detection and tracking with a surround view camera system includes arranging two or more cameras at respective two or more locations of the vehicle. The two or more cameras capture images within a field of view of the two or more cameras. The method also includes a processing system obtaining the images from the two or more cameras and performing image processing to detect and track objects in the field of view of the two or more cameras.

In addition to one or more of the features described herein, the performing the image processing includes pre-processing each of the images individually, the pre-processing including de-warping each of the images.

In addition to one or more of the features described herein, the performing the image processing includes performing visual recognition techniques to detect the objects in each of the images in which the objects appear.

In addition to one or more of the features described herein, the performing the image processing includes performing inter-image detection to detect the objects based on overlapping areas in the images obtained by the two or more cameras.

In addition to one or more of the features described herein, the performing the image processing includes performing temporal detection on a frame-by-frame basis to track movement of the objects.

In addition to one or more of the features described herein, the performing the image processing includes obtaining vehicle dynamics information about the vehicle.

In addition to one or more of the features described herein, the performing the image processing includes obtaining information from other sensors of the vehicle, the other sensors including a radar system, a lidar system, or an ultrasonic sensor system.

In addition to one or more of the features described herein, the method includes the processing system outputting information about the locations of the objects in the field of view of the two or more cameras in a vehicle coordinate system.

In addition to one or more of the features described herein, the method includes the processing system presenting the objects in the field of view of the two or more cameras in a three-dimensional bounding box (BBOX).

In addition to one or more of the features described herein, the method includes the processing system providing information about the objects in the field of view of the two or more cameras to a controller in the vehicle and the controller controlling safety and autonomous systems of the vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts an exemplary embodiment of a surround view camera system according to one or more embodiments;

FIG. 2 shows exemplary scenarios in which the surround view camera system facilitates detection and tracking of objects according to one or more embodiments;

FIG. 3 is a process flow of a method of performing object detection and tracking with a surround view camera system according to one or more embodiments;

FIG. 4 illustrates an exemplary output of the surround view camera system according to one or more embodiments;

FIG. 5 depicts two exemplary outputs of the surround view camera system according to one of more embodiments; and

FIG. 6 illustrates another exemplary output of the surround view camera system according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, forward-looking camera systems have been used for object detection. The information obtained about objects in front of the vehicle may be used for adaptive cruise control (ACC), automatic emergency braking (AEB), or forward collision warning (FCW), for example. To address other scenarios and to enhance automated systems, information is desirable about objects in proximity to the vehicle that are not necessarily only in front of the vehicle. While surround view cameras provide images around the vehicle, these camera images have not been used for object detection and tracking. Embodiments of the systems and methods detailed herein relate to a surround view camera system for object detection and tracking. As detailed, the surround view camera system is not simply an extension of the processing used in the forward-looking camera system to multiple cameras disposed around the vehicle. Instead, the multiple views can provide enhanced information that cannot be obtained with a single camera image. For example, images from each of the different views are pre-processed, overlapping images are resolved, and images in the different views are used to filter false alarms or adjust detection thresholds.

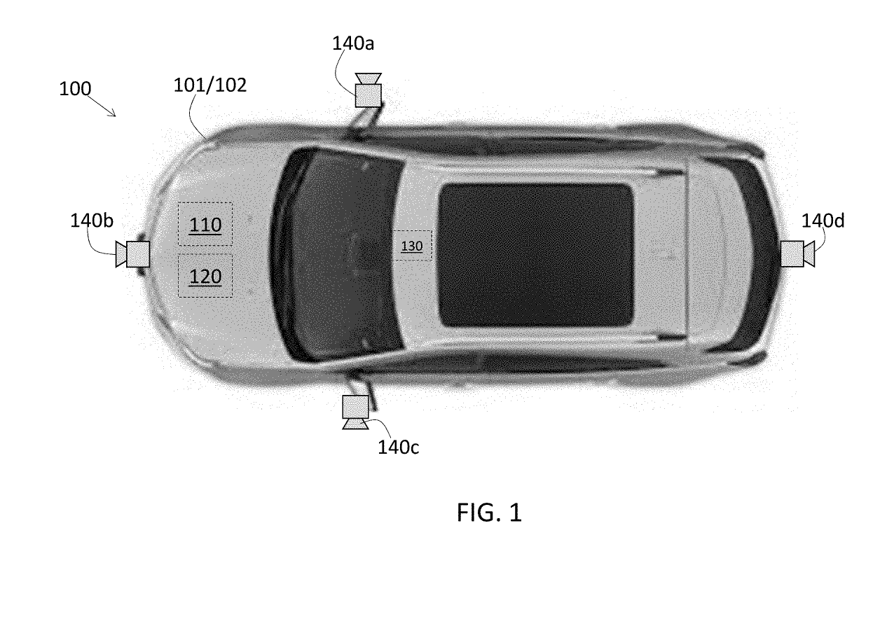

FIG. 1 depicts an exemplary embodiment of a surround view camera system 100 according to one or more embodiments. The vehicle 101 shown in FIG. 1 is an automobile 102. The surround view camera system 100 includes four cameras 140a through 140d (generally referred to as 140) in the exemplary embodiment shown in FIG. 1. Camera 140a captures images on the passenger side of the vehicle 101, and camera 140c captures images on the driver side of the vehicle 101. Camera 140b captures images from the front of the vehicle 101, and camera 140d captures images at the rear of the vehicle 101. In alternate embodiments, fewer or more cameras 140 may be used and can be arranged in other parts of the vehicle 101.

The images from the different cameras 140 are sent to the processing system 110 of the surround view camera system 100 for processing. The communication between the cameras 140 and processing system 110 may be over wires that are routed around the vehicle 101 or may be wireless. The processing system 110 may include an application specific integrated circuit (ASIC), an electronic circuit, a processor (shared, dedicated, or group) and memory that executes one or more software or firmware programs, a combinational logic circuit, and/or other suitable components that provide the described functionality. A controller 120 of the vehicle 101 is shown in FIG. 1. This controller 120 may be separate from and coupled to the processing system 110, or, in alternate embodiments, the functionality described for the processing system 110 may be performed by components of the controller 120. The controller 120 can include or communicate with systems such as the systems that perform ACC, AEB. FCW, and other safety and autonomous driving functions. Additional known sensors 130 (e.g., radar, lidar, ultrasonic sensors) may be incorporated in the vehicle 101 and may be used in the processing of information from the cameras 140.

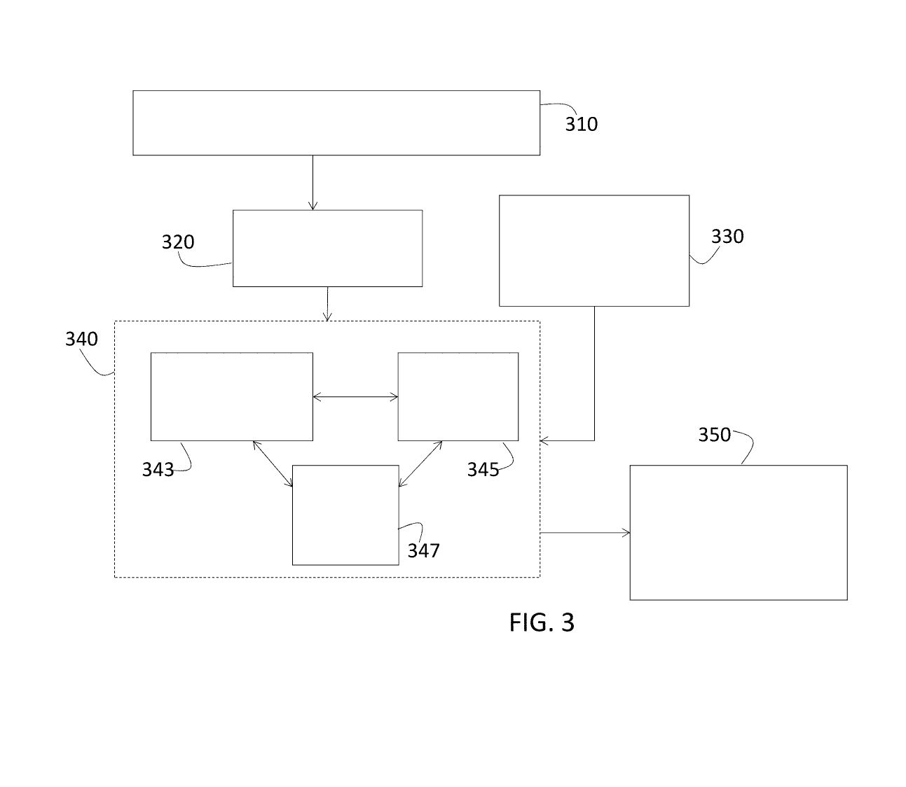

The cameras 140 may include extreme wide angle lenses such that the images obtained by the cameras 140 are distorted (i.e., fisheye images). The extreme wide angle lenses have an ultra-wide field of view and, thus, provide images that facilitate 360 degree coverage around the vehicle 101 with the four cameras 140 shown in FIG. 1. The raw images obtained with the extreme wide angle lenses also require pre-processing of the images to unwarp the image distortion or fisheye effect, as further discussed with reference to FIG. 3. The pre-processing may also include image enhancement and virtual camera view synthesis.

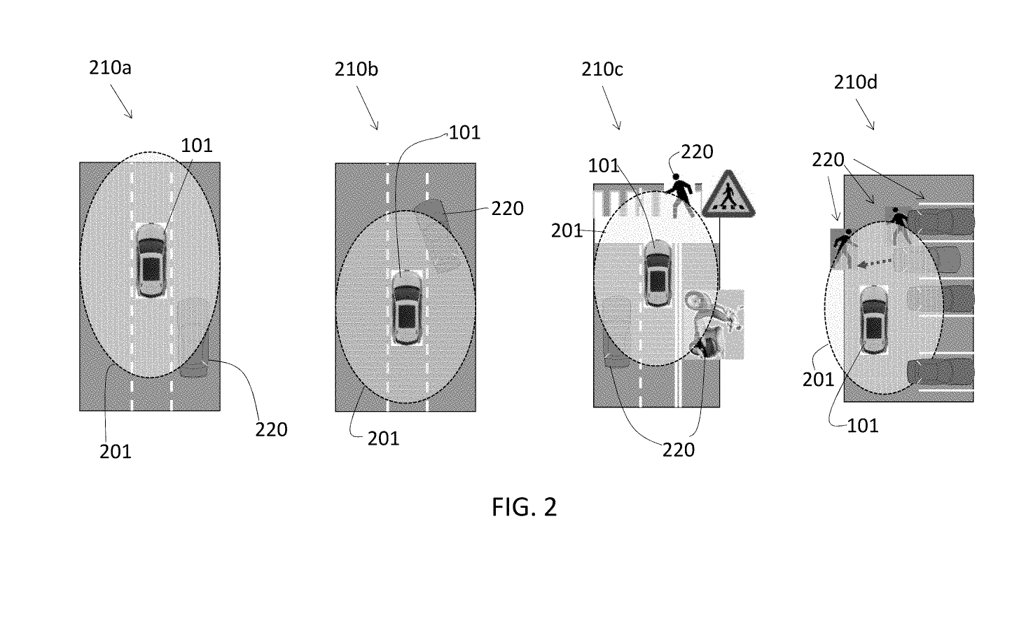

FIG. 2 shows exemplary scenarios 210a through 210d in which the surround view camera system 100 facilitates detection and tracking of objects 220 according to one or more embodiments. Scenario 210a shows an object 220, another vehicle, in a side blind zone of the vehicle 101 that includes the surround view camera system 100. The field of view (FOV) 201 of the surround view camera system 100 is indicated and shows that a portion of the object 220 is within the FOV 201. Thus, even if the object 220 is not visible in the side mirror, for example, the surround view camera system 100 will detect the object 220.

In scenario 210b, an object 220, which is another vehicle, cuts into the lane of the vehicle 101. A forward-looking camera system may only see the object 220 when it is in the position shown in FIG. 2. For example, a typical forward-looking camera system used for ACC has a 50 degree field of view, which is insufficient to capture the object 220. The object 220 may be in the A-pillar blind spot of the driver and in a blind spot of the forward-looking camera system until it cuts into the lane of the vehicle 101. According to the one or more embodiments described herein, the surround view camera system 100 can detect and track the object 220. That is, the object 220 that is cutting into the lane of the vehicle 101 in scenario 210b would be detected when it is approaching the vehicle 101 (in the position shown in scenario 210a) or when it is on the side of the vehicle 101 (between the positions shown in scenarios 210a and 210b). By detecting and tracking the object 220 while it is in the FOV 201, the surround view camera system 100 can better-prepare the driver or automated systems of the vehicle 101 for the cut-in shown in scenario 210b.

Scenarios 210c and 210d show several objects 220 that are in the FOV 201 at various positions relative to the vehicle 101. The forward-looking camera system would only detect some of the objects 220 shown within the FOV 201 of the surround view camera system 100. As further discussed with reference to FIG. 3, the multiple cameras 140 of the surround view camera system 100 also facilitate identification of false alarms and detection of low-resolution objects 220 based on the several views.

FIG. 3 is a process flow of a method of performing object detection and tracking with a surround view camera system 100 according to one or more embodiments. At block 310, the processes include obtaining images from the surround view cameras 140 by the processing system 110, which may be separate from or part of the controller 120. Pre-processing the images, at block 320, can include a number of image processing operations based on the types of images that are obtained. For example, when the cameras 140 have an ultra-wide field of view and provide fisheye images, the pre-processing includes de-warping. Camera 140 calibration parameters can be used for this known procedure. Pre-processing may also include other known procedures such as smoothing and image enhancement.

Obtaining vehicle information, at block 330, includes obtaining motion information, for example, what can aid in tracking of objects 220. Exemplary vehicle information includes speed, angle of motion, acceleration, or information from the global positioning system (GPS) receiver. This information may be provided to the processing system 110 through the controller 120 or directly from other vehicle systems that obtain information about vehicle dynamics. According to alternate or additional embodiments, the vehicle information obtained at block 330 can also include data from other sensors 130 (e.g., radar, lidar) mounted on the vehicle 101.

At block 340, operations are performed to detect and track objects 220 based on the images obtained by the cameras 140. These operations include known image processing, computer vision, and machine learning operations and may be performed by a deep learning neural network, for example. Known algorithms and processes that may be used as part of block 340 include a deep learning method, for example, a deep convolution neural network (DCNN), or other computer vision methods, such as deformable part models (DPM), along with other visual recognition techniques. The processing at block 340 facilitates organizing and outputting detection and tracking information at block 350.

The processing at block 340 includes performing individual frame detection at block 343. This process may use the known DPM algorithm, for example, to perform detection of objects 220 within each of the individual frames obtained by each of the cameras 140. Performing inter-image detection, at block 345, is also part of the processing at block 340. The inter-image detection operation involves associating and matching objects 220 that are captured by more than one camera 140 of the surround view camera system 100. Essentially, the position of an object 220 can be triangulated based on the images from two or more cameras 140. The process facilitates resolving overlapping images by filtering false alarms or adjusting detection thresholds, for example.

According to the exemplary arrangement shown in FIG. 1, the camera 140a on the passenger side of the vehicle 101 has an overlapping area in its image field with the camera 140d that is located at the rear of the vehicle 101. If, for example, the processing at block 343 detects an object 220 in a frame obtained by camera 140a in the overlapping area but does not detect that same object 220 in a frame of an obtained by camera 140d, then the detection threshold is reduced for processing of the frame from the camera 140d (at block 343). If the object 220 is still not detected, then the detection of the object 220 in the frame from camera 140a may be deemed as a false alarm. On the other hand, if both cameras 140 detect the object 220 and match their detections to determine that they detected the same object 220, the object location can be estimated from a triangulation technique based on the two (or more) cameras 140. This is one example of the inter-image detection processing (at block 345) to resolve objects 220 based on images obtained by the different cameras 140 of the surround view camera system 100.

Performing temporal detection, at block 347, is also part of the processing at block 340. The position of an object 220 that is detected (according to block 343 or, additionally, 345) is tracked in time based on its location from one frame to the next. While the temporal tracking (at block 347) relies on detection at block 343 or 345, the temporal tracking (at block 347) may enhance the detection at block 343 or 345, as well. For example, an object 220 that may otherwise be dismissed as a false alarm may instead be determined to have moved out of an overlapping area of coverage of two cameras 140 based on the temporal detection at block 347. The temporal detection (at block 347) facilitates determining the movement of an object 220 relative to the vehicle 101. For example, a determination of whether an object 220 is moving toward or away from the vehicle 101 can affect information provided to other vehicle systems (e.g., ACC, AEB) through the controller 120. That is, an object 220 moving away from the vehicle 101 may not be used to trigger the AEB system while an object 220 moving toward the vehicle 101 may trigger the AEB system.

As the discussion indicates and as shown in FIG. 3, the processing at blocks 343, 345, and 347 is inter-related and can be iterative. In addition, the processing at block 340 can use vehicle information obtained at block 330. As previously noted, the vehicle information can include information about the dynamics of the vehicle 101 and can additionally include data from other sensors 130. Some or all of this additional information can be used to resolve objects 220 in any of the processes associated with block 340. For example, tracking an object 220 using the temporal detection (at block 347) can be aided by range information to the object 220 provided by the radar or lidar systems. As another example, information about the speed or trajectory of the vehicle 101 can facilitate enhanced detection of the relative movement of an object 220.

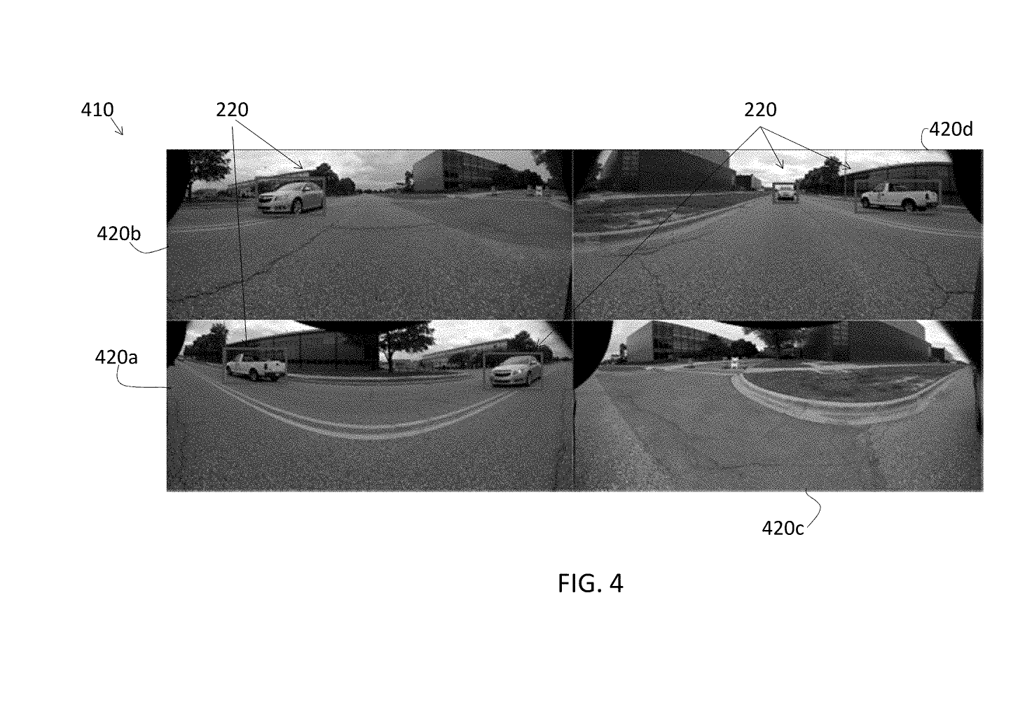

FIG. 4 illustrates an exemplary output 410 of the surround view camera system 100 according to one or more embodiments. The output 410 is a stitched-together image of four images 420a, 420b, 420c, and 420d that correspond with the exemplary camera 140 positions shown in FIG. 1. Thus, for example, image 420b is an image obtained by camera 140b at the front of the vehicle 101. Objects 220 are indicated within the images 420a through 420d by bounding boxes as shown, for example. This output 410 may be displayed for the driver and may also be provided to an advance driver assistance system (ADAS) to provide driver alerts or enhanced information, for example.

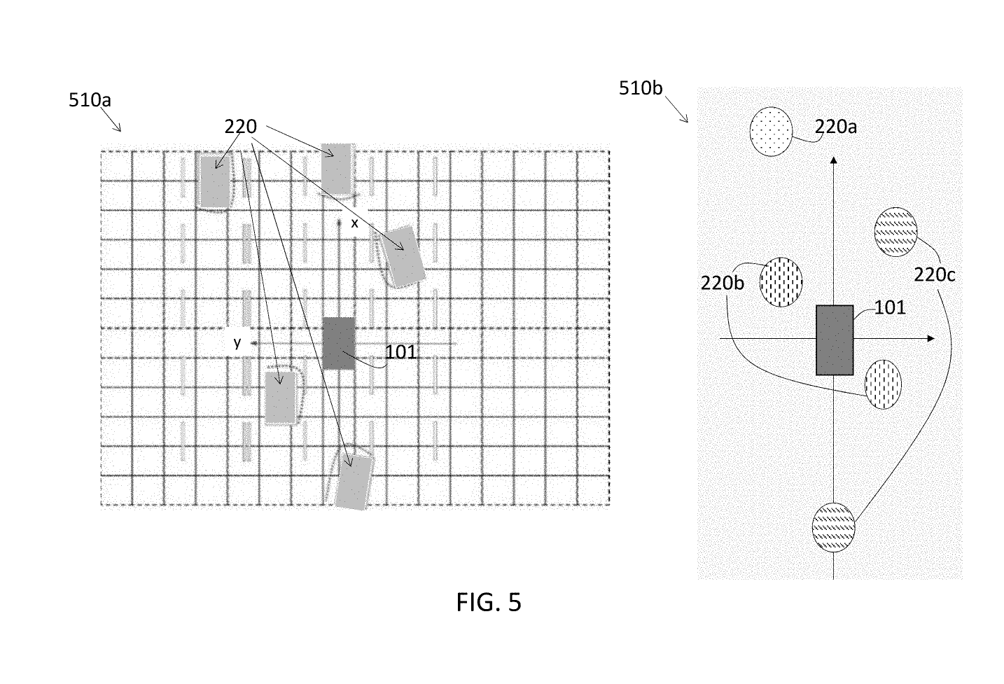

FIG. 5 depicts two exemplary outputs 510a, 510b of the surround view camera system 100 according to one of more embodiments. The outputs 510a, 510b are both on the vehicle coordinate system. Objects 220 around the vehicle 101 and the trajectory of each of the objects 220 are shown. The projection of information about the objects 220 to the vehicle coordinate system facilitates ease of communication with other vehicle systems by providing a common frame of reference. The outputs 510a, 510b can be displayed to the driver in addition to being provided to the controller 120 for coordination with other vehicle systems.

The output 510a shows a top-down view that shows the vehicle 101 and five different objects 220 around the vehicle 101. The angle of each object 220 relative to the vehicle 101 is shown and indicates the direction of travel of each object 220. The output 510b also shows a top-down view of the vehicle 101 and five objects 220 around the vehicle 101. The objects 220 may be color-coded or coded by pattern, as shown in FIG. 5. The coding may indicate direction of travel, relative speed, confidence level in detection of the object 220, or another characteristic. For example, object 220a may be a stationary object while objects 220b are moving away from the vehicle 101 (in opposite directions relative to each other) and objects 220c are moving toward the vehicle 101 (in opposite directions relative to each other). Alternately, objects 220b may be moving in a same direction as the vehicle 101 and objects 220c may be moving in an opposite direction as the vehicle 101. According to yet another embodiment, objects 220b may be slower-moving than objects 220c.

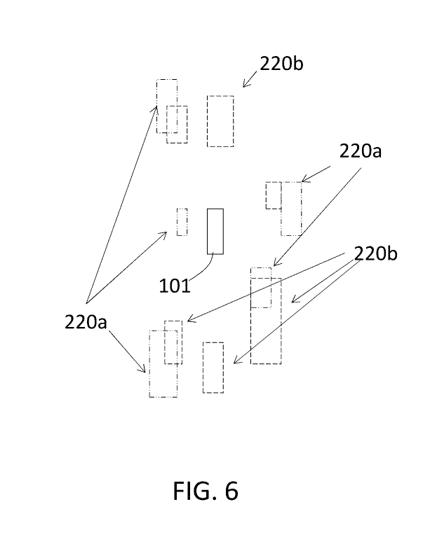

FIG. 6 illustrates another exemplary output of the surround view camera system 100 according to one or more embodiments. A three-dimensional bounding box (BBOX) is used to indicate each object 220 that is detected by the surround view camera system 100. Color or pattern coding may be used to indicate additional information about the objects 220. For example, objects 220a may have been detected by one of the side cameras 140a, 140c (FIG. 1), while objects 220b may have been detected by a front or rear camera 140b, 140d.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A surround view camera system in a vehicle, the system comprising:
two or more cameras arranged respectively at two or more locations of the vehicle and configured to capture images within a field of view of the two or more cameras; and
a processing system configured to obtain the images from the two or more cameras and perform image processing to detect and track objects in the field of view of the two or more cameras.

2. The system according to claim 1, wherein the processing system being configured to perform image processing includes the processing system being configured to pre-process each of the images individually including de-warping each of the images.

3. The system according to claim 1, wherein the processing system being configured to perform image processing includes the processing system being configured to perform visual recognition techniques to detect the objects in each of the images in which the objects appear.

4. The system according to claim 1, wherein the processing system being configured to perform image processing includes the processing system being configured to perform inter-image detection to detect the objects based on overlapping areas in the images obtained by the two or more cameras.

5. The system according to claim 1, wherein the processing system being configured to perform image processing includes the processing system being configured to perform temporal detection on a frame-by-frame basis to track movement of the objects.

6. The system according to claim 1, wherein the processing system is further configured to obtain vehicle dynamics information about the vehicle.

7. The system according to claim 1, wherein the processing system is further configured to obtain information from other sensors of the vehicle, the other sensors including a radar system, a lidar system, or an ultrasonic sensor system.

8. The system according to claim 1, wherein the processing system is further configured to output information about the locations of the objects in the field of view of the two or more cameras in a vehicle coordinate system.

9. The system according to claim 1, wherein the processing system is further configured to present the objects in the field of view of the two or more cameras in a three-dimensional bounding box (BBOX).

10. The system according to claim 1, wherein the processing system is further configured to provide information about the objects in the field of view of the two or more cameras to a controller in the vehicle, the controller being configured to control safety and autonomous systems of the vehicle.

11. A method of equipping a vehicle to perform object detection and tracking with a surround view camera system, the method comprising:
arranging two or more cameras at respective two or more locations of the vehicle and configuring the two or more cameras to capture images within a field of view of the two or more cameras; and
configuring a processing system to obtain the images from the two or more cameras and to perform image processing to detect and track objects in the field of view of the two or more cameras.

12. The method according to claim 11, wherein the performing the image processing includes pre-processing each of the images individually, the pre-processing including de-warping each of the images.

13. The method according to claim 11, wherein the performing the image processing includes performing visual recognition techniques to detect the objects in each of the images in which the objects appear.

14. The method according to claim 11, wherein the performing the image processing includes performing inter-image detection to detect the objects based on overlapping areas in the images obtained by the two or more cameras.

15. The method according to claim 11, wherein the performing the image processing includes performing temporal detection on a frame-by-frame basis to track movement of the objects.

16. The method according to claim 11, wherein the performing the image processing includes obtaining vehicle dynamics information about the vehicle.

17. The method according to claim 11, wherein the performing the image processing includes obtaining information from other sensors of the vehicle, the other sensors including a radar system, a lidar system, or an ultrasonic sensor system.

18. The method according to claim 11, further comprising configuring the processing system to output information about the locations of the objects in the field of view of the two or more cameras in a vehicle coordinate system.

19. The method according to claim 11, further comprising configuring the processing system to present the objects in the field of view of the two or more cameras in a three-dimensional bounding box (BBOX).

20. The method according to claim 11, further comprising configuring the processing system to provide information about the objects in the field of view of the two or more cameras to a controller in the vehicle, the controller being configured to control safety and autonomous systems of the vehicle.
